(19) United States
(12) Patent Application Publication
(10) Pub. No.: US 2007/0097242 A1
(43) Pub. Date: May 3, 2007

(54) Solid-state image pickup system with the number of signal readout outputs changeable and a method therefor

(75) Inventor: Hiroyuki Oshima, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/580,050

(22) Filed: Oct. 13, 2006

(30) Foreign Application Priority Data
Oct. 27, 2005 (JP) 2005-312174

(51) Int. Cl. H04N 3/14; H04N 5/335

(52) U.S. Cl. 348/312

(57) ABSTRACT

A solid-state image pickup device generates a control signal responsive to an operating signal providing at least one of the operating, setting and environmental conditions. Based on the control signal, a timing signal generator and a driver generate timing and driving signals, respectively. Signal charge read out from the photosensitive cells is transferred in response to vertical and horizontal driving signals. The signal charge transferred is output in the form of-plural output signals, responsive to respective control signals generated from the control signal, via at least one of the output amplifiers for the respective horizontal transfer path sections. The image pickup system achieves signal readout at a high speed with the number of readout outputs freely changeable to improve the image quality.

### BACKGROUND OF THE INVENTION

1. Field of the Invention

The present invention relates to a solid-state image pickup system and a method for controlling the driving of a solid-state image pickup device. Specifically, the present invention relates to a solid-state image pickup system in which an image pickup device has a plurality of output amplifiers and is configured to be driven depending on control for those output amplifiers, and to a method for controlling the driving of a solid-state image pickup device in which a control signal is generated dependent upon a condition as occasionally set to drive the solid-state image pickup device.

2. Description of the Background Art

A CCD (charge coupled device) type solid-state image pickup device includes photosensitive cells or photodiodes adapted for receiving incident light to produce signal charges corresponding to the volume of the received incident light. The CCD type solid-state image pickup device reads out signal charges, stored in the photodiodes, to a vertical transfer path, to transfer sequentially the signal charges, stored in the photodiodes, on the vertical transfer path and then on a horizontal transfer path in a bucket brigade manner. The signal charges transferred to an output circuit are ultimately converted by the output circuit into a corresponding voltage signal which is then output.

In the solid-state image pickup device, a demand is raised for increasing the number of pixels to be displayed, in order to improve the image quality. However, when the number of pixels is increased, the pixel data readout speed is lowered, because of limitations imposed on the charge transfer speed over the charge transfer paths. With the aim of increasing the transfer speed, if the driving frequency is increased, the charge transfer deterioration or the shortage of the frequency band at the output circuit become of a problem. This indicates that difficulties are encountered in significantly increasing the charge transfer speed.

Several methods have so far been proposed for overcoming the above problem for increasing the readout speed of image data. For example, there is proposed in Japanese patent laid-open publication No. 22667/1993 a solid-state image pickup system in which the readout speed may be increased without increasing the driving frequency. In this solid-state image pickup system, the photosensitive array of an image pickup zone is divided into four sections or zones, and vertical and horizontal transfer paths are independently formed for each of these sections. Moreover, signal charges are generated in the respective zones resulting from the division. In the solid-state image pickup system, signal charges may be read out from the four zones within a period of time which is one-fourth of the usual signal charge readout time. In the solid-state image pickup system, temporal position relationships among the four channels of the signal outputs, obtained from the four zones, are adjusted in a signal processor system to produce a video output.

In Japanese patent laid-open publication No. 2004-159033, there is proposed a solid-state image pickup device, and a driving method therefor, which has its horizontal transfer path divided at the mid point as a boundary into transfer subsections along which signal charges are conducted in the directions opposite to each other. In order to eliminate the problem that two-phase driving causes charges to be transferred in the fixed left and right directions, this solid-state image pickup device proposed is also adapted to freely set the signal charge transfer direction only to left or right. In this solid-state image pickup device, three or more-phase driving clocks are separately supplied to the transfer electrodes, and the phases of the driving clocks, supplied to the transfer electrodes, in the transfer sections of the horizontal transfer path, are switched, depending on the prevailing transfer modes.

With the above-described Japanese publication No. 22667/1993, in which the transfer paths and the output circuits are provided separately for the pixel zones, resulting from the division, the transfer directions are fixed and cannot be set freely. Additionally, with this solid-state image pickup device, the difference between the signals is outstanding under higher temperature or higher optical sensitivity set. With the Japanese publication 2004-159033 indicated above, the horizontal transfer path is driven with three phases. However, in this case, the risk is high that the three-phase driving may give rise to deterioration in charge being transferred.

### SUMMARY OF THE INVENTION

It is an object of the present invention to provide a solid-state image pickup system and a method for controlling the driving of a solid-state image pickup device according to which signal readout speed may be increased and the number of readout outputs is freely selectable to improve the image quality.

In accordance with the present invention, there is provided a solid-state image pickup system, including a solid-state image pickup device, in which photosensitive cells for photoelectrically transducing incident light into signal charge, used as pixels, are arranged in a two-dimensional array. The signal charge stored in the photosensitive cells is read out to a vertical transfer path adapted for transferring the signal charges stored in the photosensitive cells in the vertical direction. The signal charge read out is transferred to a horizontal transfer circuit adapted for transferring the signal charge read out in the horizontal direction. The signal charge transferred to the horizontal transfer circuit is further transferred to output circuitry arranged in an ultimate stage of the horizontal transfer circuit, and is output from the output circuitry. The horizontal transfer circuit includes a first horizontal transfer path for transferring the signal charge in one direction, and a second horizontal transfer path for transferring the signal charge in part towards left and in part towards right with respect to a predetermined boundary. The output circuit includes a first output circuit for converting signal charge transferred from the first horizontal transfer path into an analog signal, a second output circuit for converting signal charge transferred from the second horizontal transfer path towards left into an analog signal, and a third output circuit for converting signal charge transferred from the second horizontal transfer path towards right into an analog signal. The solid-state image pickup system also includes a controller for generating a control signal for exercising control responsive to an operating signal providing at least one of operating, setting and environmental conditions, and a timing generator for generating a timing signal consistent with the control signal. The system further includes a driving generator for controlling the driving of the output circuitry responsive to the control signal supplied and for generating a driving signal from the timing signal consistent with the control signal.

In the solid-state image pickup system, according to the present invention, a control signal for exercising control is generated responsive to an operating signal providing at least one of the operating, setting and environmental conditions. The timing generator and the driving generator generate timing and driving signals, respectively, from the control signal supplied. Signal charge read out is transferred responsive to the driving signal supplied. The signal charge transferred is output from the first output circuit or from the second and third output circuits in the first horizontal transfer path, responsive to the control signal, thus achieving both the high speed readout and the high image quality of an image read out in combination.

In accordance with the present invention, there is provided a method for driving a solid-state image pickup device in a solid-state image pickup system, in which photosensitive cells for photoelectrically transducing incident light into signal charges, used as pixels, are arranged in a two-dimensional array. The signal charge stored in the photosensitive cells is read out and transferred in the vertical direction. The signal charge transferred in the vertical direction is transferred to an output side and output by a plurality of output circuits configured for converting the signal charges into an analog signal. The method according to the present invention includes a first step of generating a control signal responsive to an operating signal providing at least one of operating, setting and environmental conditions. The method also includes a second step of generating vertical and horizontal timing signals consistent with the control signal, and a third step of controlling the output circuits to single drive or to multiple drive responsive to the control signal supplied and generating vertical and horizontal driving signals from the vertical and horizontal driving signals consistent with the control signal. The second step generates a vertical timing signal for providing for opposite vertical transfer directions for a first case of controlling the output circuits to one-output driving and a second case of controlling the output circuits to a multiple-output driving. The second step generates a horizontal timing signal for the second case for transferring a packet for transporting the signal charge in the horizontal transfer towards the output circuits for the multiple-output driving, with respect to a predetermined boundary. The horizontal transfer path, provided with the plural output circuits, is provided with separate interconnections for conveying the horizontal driving signal different on both sides of the predetermined boundary. Thus, as the horizontal driving signal is supplied, the packets transporting the signal charge is formed in order in the directions towards the output circuits.

In the driving method for the solid-state image pickup device, according to the present invention, a control signal is generated responsive to an operating signal providing at least one of operating, setting and environmental conditions. Vertical and horizontal timing signals consistent with the control signal are generated. The output circuits are controlled to single drive or to multiple drive responsive to the control signal supplied. Vertical and horizontal driving signals are generated from the vertical and horizontal driving signals consistent with the control signal. The vertical timing signal is generated for providing for opposite vertical transfer directions for the first case and the second case. For the second case, the horizontal timing signal is generated for transferring a packet for transporting the signal charge in the horizontal transfer towards the output circuits for the multiple-output driving, with respect to a predetermined boundary. The horizontal transfer path, provided with the plural output circuits, is provided with separate interconnections for the horizontal driving signals, different on both sides of the predetermined boundary. In this manner, as the horizontal driving signal is supplied, packets transporting the signal charge are formed in order in the directions towards the respective output circuits, thus achieving high speed readout and high image quality of the image as read out in combination.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the constitution of a CCD type image pickup unit and a driver, employing an image pickup device of the image pickup system according to the present invention;

FIG. 2 is a schematic diagram showing the electrical connections of vertical driving signals supplied to the electrodes of the vertical transfer path in the image pickup unit of FIG. 1;

FIG. 3 is a schematic diagram showing the electrical connections of horizontal driving signals supplied to electrodes of the horizontal transfer path in the image pickup unit of FIG. 1;

FIG. 4 is a schematic block diagram showing a preferred embodiment of a digital camera employing the solid-state image pickup system of the present invention;

FIG. 5 is a timing chart showing the timings of driving signals and output signals used in one-output readout in the digital camera of FIG. 4;

FIG. 6 is a timing chart enlarged with respect to the time axis and showing the timings of the driving signals and the output signals used in the one-output readout of FIG. 5;

FIG. 7 is a timing chart showing the timings of driving signals and output signals used in two-output readout in the digital camera of FIG. 4;

FIG. 8 is a timing chart enlarged with respect to the time axis and showing the timings of the driving signals and the output signals used in the two-output readout of FIG. 7;

FIG. 9 is a timing chart showing the timings of driving signals and output signals used in three-output readout in the digital camera of FIG. 4; and

FIG. 10 is a timing chart enlarged with respect to the time axis and showing the timings of the driving signals and the output signals used in the three-output readout of FIG. 9.

### DESCRIPTION OF THE PREFERRED EMBODIMENT

With reference to the accompanying drawings, a preferred embodiment of the solid-state image pickup system according to the present invention will be described in detail. In the illustrative embodiment, the solid-state image pickup system according to the present invention is applied to a digital camera 10. The parts or components not directly relevant to understanding the present invention will not be shown nor described.

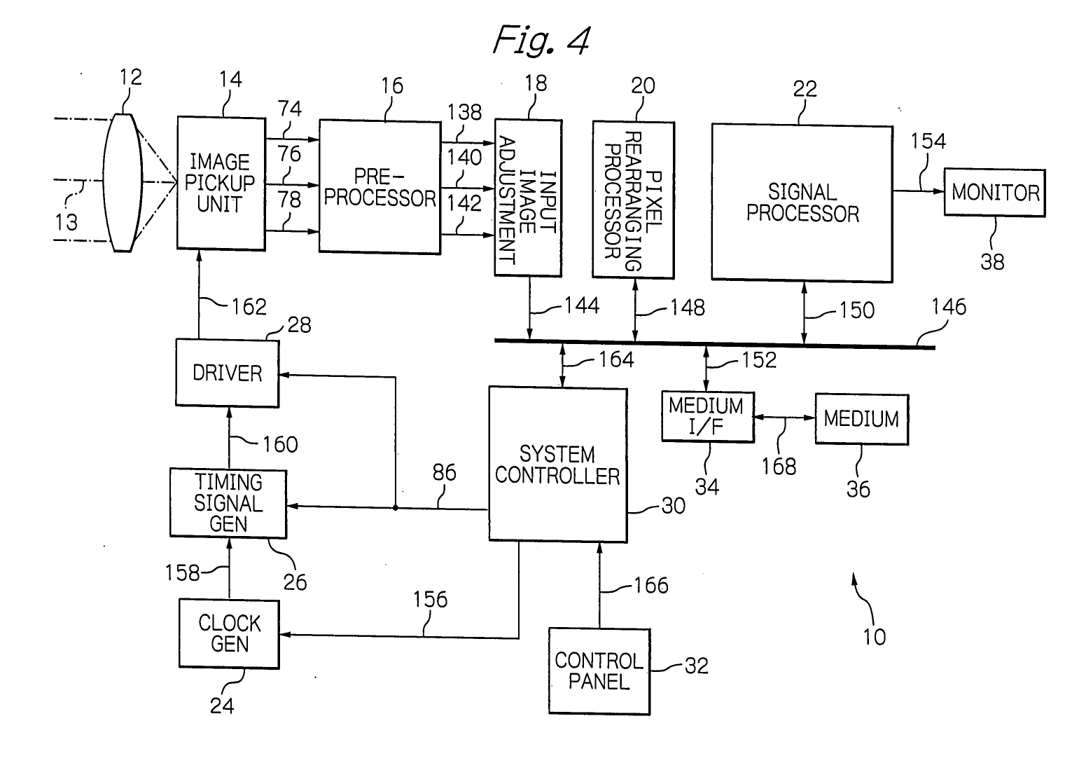

With reference first to FIG. 4, the digital camera 10 of the instant embodiment includes an optical system 12, an image pickup unit 14, a pre-processor 16, an input image adjustment unit 18, a pixel rearranging processor 20, a signal processor 22, a clock generator 24, a timing signal generator 26, a driver 28, a system controller 30, a control panel 32, a medium interface (I/F) unit 34, a recording medium 36 and a display monitor 38, which are interconnected as shown in the figure.

The optical system 12 has the function of receiving light 13 incident from a subject field being captured to form an image having its angle of field matched to the operation on the control panel 32 on the photosensitive array of the image pickup unit 14. The optical system 12 adjusts the angle of field or the focal length responsive to a zooming operation or to the half-stroke depression of a shutter release key, not shown, on the control panel 32.

The image pickup unit 14 includes a color filter comprised of color filter segments which are disposed in register with the locations of the photodiodes in the incoming direction of incident light 13. The image pickup unit 14 has the function of color-separating the incident light 13 by the respective color filter segments, causing the color components of the incident light 13, resulting from color separation, to fall on the photodiodes, arranged in a two-dimensional array, and transducing the light of the color components, resulting from the color separation, into corresponding signal charges, by the photodiodes to output the electrical signals.

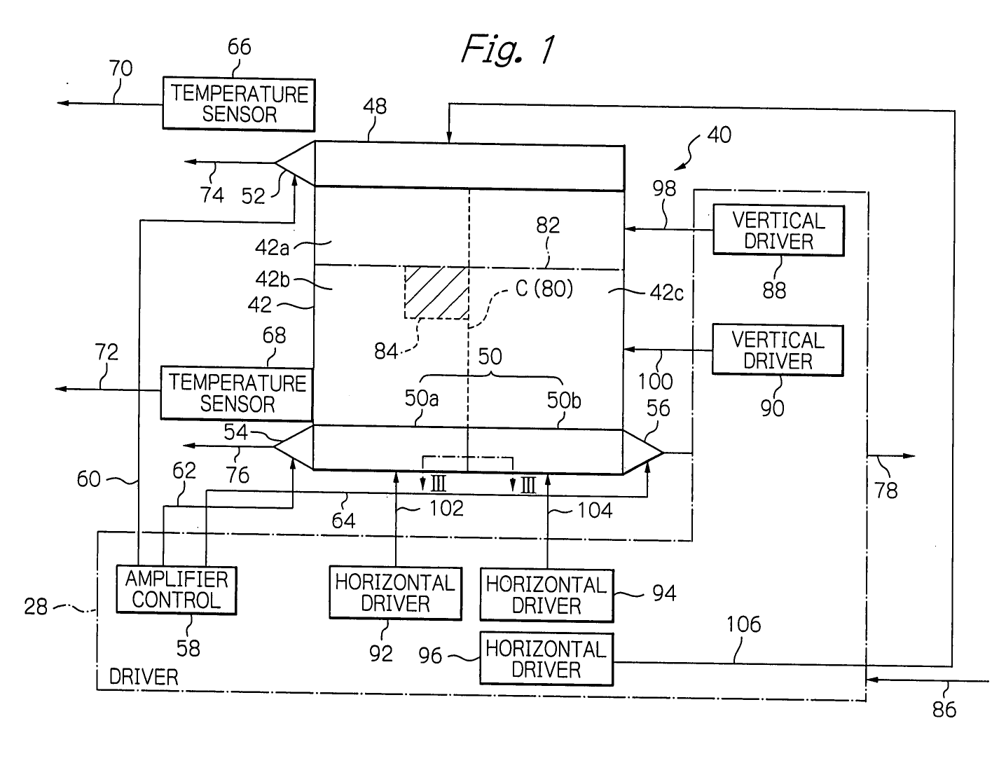

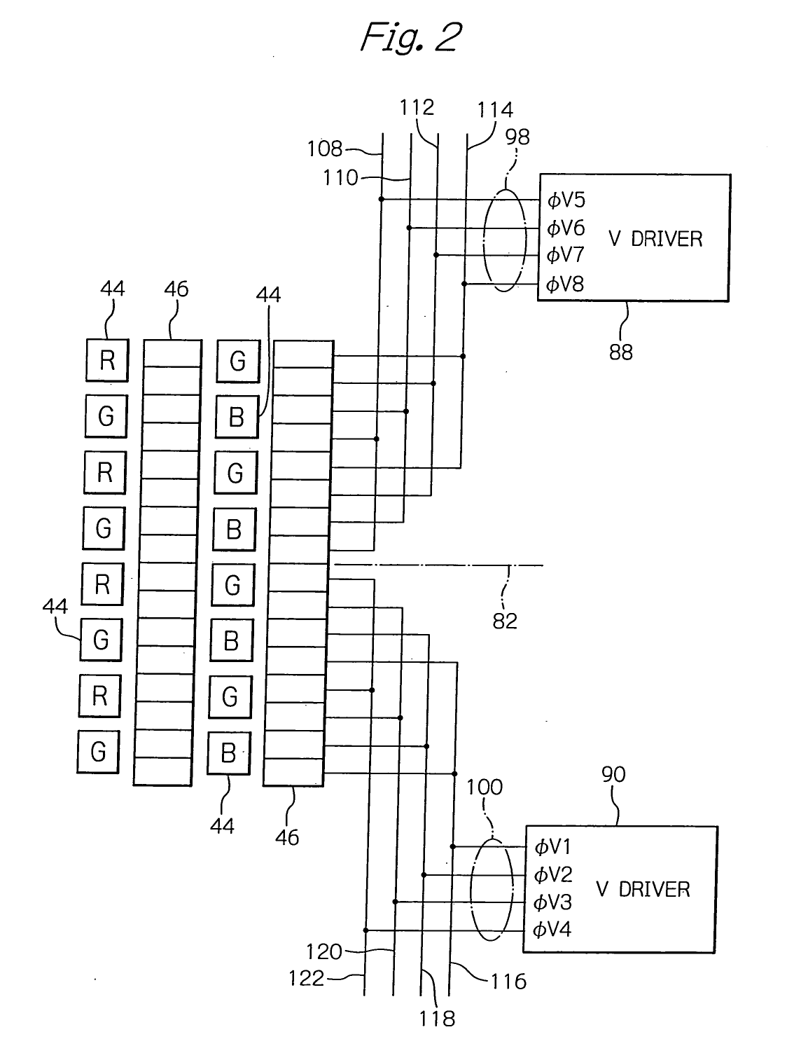

In an image pickup device 40 of the instant embodiment, there is formed an effective pixel zone 42, comprised of the two-dimensional array of photodiodes, as shown in FIG. 1. As shown in FIG. 2, the signal charges, produced in the photodiodes 44, are readout via a field shift gate, not shown, to a vertical transfer path 46, from the photodiodes 44. The signal charges, thus read out, are vertically transferred, on the vertical transfer path 46, responsive to the vertical driving signals supplied. The direction of vertical transfer can be switched depending on the phase of the vertical driving signal supplied. The direction of vertical transfer will be described in further detail subsequently.

Meanwhile, “R”, “G” and “B”, entered in square blocks of the photodiodes 44 in FIG. 2, denote color filter segments. Although the photodiodes 44 of FIG. 2 are arrayed in a square lattice configuration, they may alternatively be arrayed with an offset by one-half pixel pitch, in accordance with so-called honeycomb configuration. In the latter case, the image pickup device may operate similarly to the present embodiment.

Returning to FIG. 1, the image pickup device 40 includes horizontal transfer paths 48 and 50 in upper and lower parts of the effective pixel zone 42, respectively. The horizontal transfer path 50 is divided into horizontal transfer path sections 50a and 50b, with respect to a centerline C of the effective pixel zone 42 as a boundary. The horizontal transfer path 48 is used for one-output readout or for two-output readout, while the horizontal transfer path sections 50a and 50b are used for two-output readout or for three-output readout. The horizontal transfer path 48 has its output end provided with an output amplifier 52, while the horizontal transfer path sections 50a and 50b have the output ends thereof provided with output amplifiers 54 and 56, respectively. The output amplifiers 54 and 56 are provided with the function of converting signal charges, supplied thereto, into an analog voltage signal. The output amplifiers 52, 54 and 56 are operated responsive to control signals 60, 62 and 64, supplied thereto as operation enable signals from the amplifier control circuit 58 included in the driver 28. In the following description, signals are denoted with reference numerals of connections on which they appear.

Adjacent to the output amplifiers 54 and 56, there are provided temperature sensors 66 and 68 mounted on-chip on the image pickup device 40. The temperature sensors 66 and 68 output analog signals 70 and 72 as the analog information indicating the temperature at and around the output amplifiers 52 and 54. In the present embodiment, no temperature sensor is provided for the output amplifier 56, because the operation of the output amplifier 56 is similar to that of the output amplifier 54 and hence it may be presumed that the heat attendant on the operation is generated in the output amplifier 56 in much the same way as in the output amplifier 54. However, the temperature sensor may be provided not only in the output amplifier 54 but also in the output amplifier 56.

The output amplifiers 52, 54 and 56 produce output signals 74, 76 and 78, subject to the supply thereto of control signals 60, 62 and 64 associated with the one-output readout, two- output readout and the three-output readout, respectively. The output signals 74, 76 and 78 are output signals OS1, OS2 and OS3, as will later be described, respectively.

Meanwhile, in the case of one-output signal readout from the effective pixel zone 42 of the image pickup device 40, the signal charges, read out from the entire zone, are transferred towards the horizontal transfer path 48. In the case of two-output signal readout, the effective pixel zone 42 is divided into two sub-zones, as indicated by a broken line 80, and signal charges are transferred towards the horizontal transfer paths 48 and 50. In the case of three-output readout, the effective pixel zone 42 is divided into three zones of approximately equal areas. A first zone 42a lies above a dot-and-dash line 82 and reaching the horizontal transfer path 48, whilst second and third sub-zones 42b and 42c lie below the dot-and-dash line 82 and further divided from each other by the broken line 80.

In the case of mid-area weighted photometry, i.e. when photometry is mainly effected in a mid area, for example, of the effective pixel zone 42, an area 84 used for photometry is provided at the mid part of the sub-zone 42b. This area for photometry 84 may also be provided in the sub-zone 42c. The division of the effective pixel zone 42 may be based on the numbers of the electrodes in the horizontal transfer and in the vertical transfer, in addition to, or instead of, on the equal areas of the sub-zones resulting from the division. The image pickup device 40 is preferably operated depending on the particular manner of division used.

The image pickup device 40 is operated in response to a variety of driving signals supplied from the driver 28. The driver 28 has the function of generating the various driving signals responsive to the control signal 86 supplied from the system controller 30 and to a timing signal from the timing generator 26, not shown in FIG. 1. The driver 28 includes an amplifier control circuit 58, vertical (V) drivers 88 and 90, and horizontal (H) drivers 92, 94 and 96, for implementing this function. The vertical drivers 88 and 90 output vertical driving signals 98 and 100, respectively. The vertical driving signals 98 and 100 are generated responsive to the control signal 86 and to the vertical timing signal. Four vertical driving signals are supplied from each of the vertical drivers 88 and 90 to the respective electrodes of the vertical transfer path 46, over signal lines 108 to 122, as shown in FIG. 2. In the case of three-output readout, in particular, the wiring structure may be correspondingly divided in order to make distinction between the vertical driving signals 98 and 100 with the dot-and-dash line 82 as a boundary. As for vertical driving, respective outputs will be described subsequently.

The drivers 92, 94 and 96 output horizontal driving signals 102 and 104 and 106, respectively. The horizontal driving signals 102 and 104 and 106 are generated responsive to the driving signal 86 and to the horizontal timing signal.

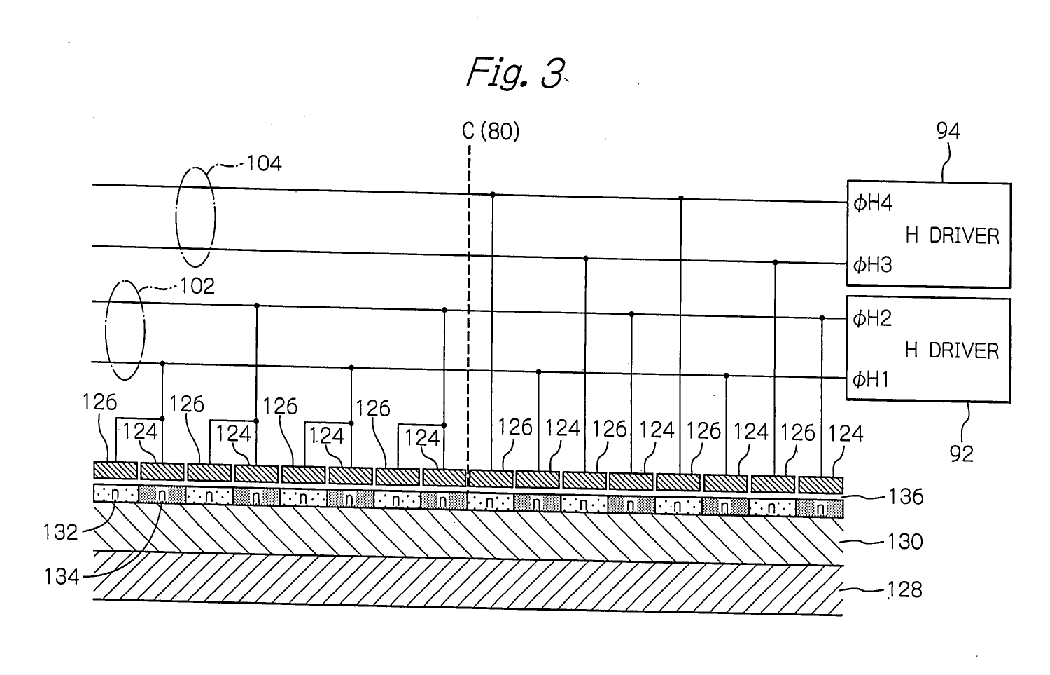

Now, attention is directed to the horizontal transfer path 50 (horizontal transfer path sections 50a and 50b) as one of the characteristics of the present embodiment. FIG. 3 shows the cross-section along a dot-and-dash line III-III in FIG. 1. Four-phase horizontal driving signals ΦH1 to ΦH4 are applied to the horizontal transfer path 50.

The instant embodiment is specifically featured by the following points. That is, in the horizontal transfer path section 50a, lying from the centerline towards the left side, two neighboring electrodes 124, 126 are electrically interconnected to form a set of electrodes. This combination of electrode dispositions is repeated. To the electrode sets lying adjacent to the centerline C (80) towards the left end are applied horizontal driving signals ΦH2 and ΦH1. In the horizontal transfer section 50b, lying towards right from the centerline C (80), the electrodes 124, 126 are connected to distinct wires, in a manner independent of each other. This electrode connection is repeated. In the horizontal transfer path section 50b, lying from the centerline C (80) towards the right side, the horizontal driving signals ΦH4, ΦH1, ΦH3 and ΦH2 are applied. If the electrodes 124, 126 are considered to be assorted as a set, as described above, then the number of the electrode sets is equal to the number of stages, or columns, of the vertical transfer paths. This is correlated with the fact that a line memory, not shown, is provided between the vertical transfer path 46 and the horizontal transfer path 50. By providing the line memory in this manner, only signal charges of the vertical transfer path, or column, connected to the line memory may be read out and temporarily stored in the horizontal transfer path 50.

When fabricating the horizontal transfer path 50, there is formed, on the primary surface layer of a semiconductor substrate 128 of a given conductivity type, a well layer 130 of a conductivity type opposite to that of the substrate is formed. On the surface layer side of the well layer 130 formed, there are formed impurity layers 132 and 134, corresponding to a transfer channel, which are of the conductivity type opposite to that of the well layer 130. The impurity layers 132 and 134 will form a transfer channel. The one impurity layer 134 is heavier in concentration than the other impurity layers 132. Over the substrate 128, there are formed the electrodes 126 via an insulating layer 136, while there are also formed the electrodes 124, via the insulating layer 136, with respect to the electrodes 126 and the substrate 128. As a result, the impurity layers 132 and 134 are formed below the electrodes 126 and 124, respectively. However, the pitch of the electrodes 124 differs from that of the electrodes 126.

The horizontal transfer path 48 has the cross-sectional shape similar to that shown in FIG. 3, although the cross-sectional shape of the horizontal transfer path 48 is not shown. The constitution of the horizontal transfer path 48 is the same as that of the left part with respect to the centerline C (80) of FIG. 3. Preferably, the clock rate of the horizontal driving signals ΦH5 and ΦH6 (106), applied to the horizontal transfer path 48, is made variable against that of the horizontal driving signals 102 and 104, output from the horizontal drivers 92 and 94, respectively.

Returning now to FIG. 4, the image pickup device 40 of the image pickup unit 14 outputs one to three channels of analog electrical signals 74, 76 and 78 to the pre-processor 16.

The pre-processor 16 has an analog front-end (AFE) function. This function includes noise removal for analog electrical signals 74, 76 and 78 by correlated double sampling (CDS) and digitization, that is, analog-to-digital (A/D) conversion, of the noise-freed one to three channels of the analog electrical signals. It is noted that the pre-processor 16 is supplied with three channels of the analog electrical signals 74, 76 and 78. If only a sole channel of the analog electrical signals is input, the operation of the CDS sampling and A/D conversion may be activated only for the sole channel. In this case, the pre-processor 16 outputs image data to the input image adjustment unit 18. The pre-processor 16 pre-processes the input of two channels to transmit output signals 140 and 142 of the so-processed two channels to the input image adjustment unit 18. Additionally, the pre-processor 16 may be adapted to pre-process the input of three channels to transmit output signals 138, 140 and 142 on the three channels, thus pre-processed, to the input image adjustment unit 18.

The input image adjustment unit 18, FIG. 4, has the function of receiving image data depending on the number of simultaneously supplied output data on the channels, that is, on the number of inputs, when being two or more. It is particularly desirable that the output signals 142 and 144, or the output signals 138, 140 and 142, simultaneously supplied as outputs of the two or three channels, shall be sampled at a sampling frequency which is equal to or two to three times as high as the frequency of the above output signals. The input image adjustment unit 18 may also store the output signals 138, 140 and 142, supplied as described above, in its memory, not shown, in addition to having the above sampling function. The resulting output signals 144 are supplied over a bus 146 and a signal line 148 to the pixel rearranging processor 20.

The pixel rearranging processor 20 has the function of correcting the sequence of pixel data, when obtained on the 2-channel or 3-channel outputs, into a dot-sequential order, for example, for the scanning lines, so as to assemble the image data into a sole image. If the output from the pre-processor 16 is one channel data, it is then unnecessary for the input image adjustment unit 18 and the pixel rearranging processor 20 to adjust or change the sequence of input image data. In this case, the pixel rearranging processor 20 is bypassed so as to transmit the image data obtained 144 over bus 146 and signal line 150 to the signal processor 22.

The signal processor 22 has the function of synchronizing, i.e. providing for the same output timing of, image data supplied and converting the so timing-adjusted image data to luminance/chrominance (Y/C) signals. The synchronization of image data supplied means providing for the same timing for producing the R, G and B data of the same pixel and outputting the data at the same timing. The signal processor 22 also has the function of converting the Y/C signals thus produced into for example the signals appropriate for being displayed on a liquid crystal monitor, and the function of compressing the Y/C signals produced, or decompressing the compressed signals, depending on the recording mode, for restoring and reproducing the original data. Among the recording modes, there are a JPEG (Joint Photographic Experts Group) mode, an MPEG (Moving Picture Experts Group) mode and a raw data mode. The signal processor 22 also routes the image data, processed to any one of the above recording modes, over bus 146 and signal line 150, to the medium I/F circuit 34. Additionally, the signal processor 22 outputs a signal 154 for displaying on the liquid crystal monitor to the display monitor 38.

The clock generator 24 has the function of generating a reference clock signal 158. The clock generator 24 generates the reference clock signal responsive to a control signal 156 from the system controller 30. The clock generator 24 outputs the so generated clock signal 158 to the timing signal generator 26. The clock generator 24 may have the function of supplying the pre-processor 16 with the clock, which will be used as a sampling frequency, depending on the number of the output channels of the output signals 74, 76 and 78.

The timing signal generator 26 has the function of generating a variety of timing signals, such as vertical and horizontal synchronous signals, a field shift gate signal, vertical and horizontal timing signals, and an OFD (Over-Flow Drain) signal. This function is responsive to the control signal 86 from the system controller 30 to generate a variety of timing signals 160. The timing signal generator 26 outputs a variety of timing signals 160 to the driver 28. In particular, the timing signal generator 26 receives a command on which the number of the outputs of the image pickup unit 14 is to be, by the control signal 86, and transmits the timing signals 160 to the driver 28, in the vertical and horizontal directions, depending on the driving directions of the vertical transfer path 46 and the horizontal transfer paths 48 and 50. The timing signal generator 26 may also have the function of generating a variety of sampling signals or the operating clock used not only in the image pickup unit 14 but also in various parts including the pre-processor 16.

The driver 28 has the function of using the various timing signals 160, supplied thereto to generate vertical and horizontal driving signals, depending on the prevailing driving mode. The driver 28 also generates vertical and horizontal driving signals 162, responsive to the control signal 86, supplied thereto, and outputs the so generated driving signals to the image pickup unit 14. The driver 28 also actuates the amplifier control circuit 58, responsive to the control signal 86, supplied thereto, while controlling the operation of the output amplifiers 52, 54 and 56. Thus, the driver 28 is able to cause selective operations of the output channels or to halt the driving operation. In particular, when the one output channel is selected, the operation of the output amplifiers 54 and 56 is halted. If the two outputs channel is selected, then the operation of the output amplifier 52 is preferably halted.

The system controller 30 has the function of generating a variety of control signals responsive to an operating signal 164 from the control panel 32 as will later be described. In particular, the system controller 30 has the function of generating a control signal depending on the setting of high sensitivity readout mode, the support of temperature variations, the automatic exposure (AE) and automatic focusing (AF) features, and the setting of a picture resolution/frame rate. With the setting of high sensitivity readout mode, the support of temperature variations and the setting of the low resolution/low frame rate, a one-output control signal is generated. With the setting of high resolution/high frame rate for shooting moving pictures or for high-speed consecutive shooting of still images, and with the setting for readout at ordinary sensitivity mode, a two-output or a three-output control signal is generated. In coping with the AE and AF features, a three-output control signal is generated.

In the setting for high sensitivity readout mode, if a value of ISO (International Standards Organization) sensitivity is set which is higher than a preset threshold value, then a control signal for one-output readout is generated and output.

In coping with variations in temperature, if the temperature of the image pickup device 40 indicates rise or fall significantly far from the ambient temperature, a control signal for one-output readout is generated and output. In the present embodiment, the on-chip temperature sensors 66 and 68 of the image pickup device 40 detect the temperature. The temperature sensors 66 and 68 output detected analog signals 70 and 72. The analog signals 70 and 72 are transmitted to, for example, the signal processor 22 and digitized via the A/D converter, not shown, so as to be supplied as temperature information. The system controller 30 acquires the temperature information, obtained in the signal processor 22, over the signal line 150, bus 146 and the signal line 164. A temperature threshold value is set beforehand in the system controller 30. Preferably, two temperature threshold values may be set, namely a high side temperature threshold value and a low side temperature threshold value. The system controller 30 compares the temperature threshold value as set to the temperature information as detected. The system controller 30 generates a control signal for performing control to the one-output readout, depending on the temperature environment, that is, when the temperature information is higher than the high side temperature threshold value or lower than the low side temperature threshold value, and outputs the so generated control signal.

It may be an occurrence that, if the temperature information as obtained indicates that the temperature of the image pickup device is close to the temperature threshold value, only slight changes in the temperature environment affect the quality of the image obtained. In this consideration, the system controller 30 not only exercises control based on the temperature threshold value as a sole parameter, but also sets a threshold value of temperature variations relative to this temperature threshold value, and checks to see whether or not the temperature has varied beyond this threshold value of temperature variations. As a result of this check, if a variation greater than the preset variations in temperature has been detected, the system controller 30 may generate and output a control signal for performing control for one-output readout.

In coping with the AE or AF feature, in particular with the AE feature, if the signal charges are read out from the area 84 in the effective imaging zone, the signal charges are vertically transferred towards the horizontal transfer path sections 50a and 50b, and the then over the horizontal transfer path sections 50a and 50b by two-output readout, thus attaining high-speed readout. This is valid in the AF feature, i.e. automatic focus-ranging and focusing, as well. In addition, if the resolution/frame rate is lower than the predetermined value, the system controller 30 generates and outputs a control signal for one-output readout.

In this manner, the system controller 30 outputs the control signal 86, thus generated, to the timing signal generator 26 and to the driver 28. When the system controller 30 exercises control to one-output readout, the control signal 86 carries the information for halting the operation of the other two outputs. This enables a seamless image to be easily obtained without dividing the photosensitive array or photodiodes. On the other hand, when the system controller 30 exercises control to two-output readout, the control signal 86 carries the information for halting the readout operation of the remaining one output. It is possible to reduce power consumption by accurately exploiting the information contained in the control signal 86 supplied.

The control panel 32 includes a power supply switch, a zoom button, a menu display selector switch, a decision key, a moving picture mode setting unit, a consecutive shooting speed setting unit and a shutter release button, although not specifically illustrated. The control panel 32 has the function of transmitting an operating signal 166, representing a user's operation command, to the system controller 30. The power supply switch may be manipulated for turning the power supply for the digital camera 10 on or off. The zoom button is used to adjust the angle of view of an imaging subject field to be captured, inclusive of an object, while adjusting the focal length of the object subject to this adjustment. The menu display selector switch is manipulated to select menu items displayed on the liquid crystal monitor 38 to shift a selection cursor thereon, and may, for example be a cross-key. The decision key is used to fix the selection on a menu item.

The moving picture mode setting unit sets whether or not a moving picture is to be displayed on the liquid crystal monitor 38 by, for example, a flag value. By this setting, the digital camera 10 will display an image of the field captured on the monitor 38 as a through-image. In the moving picture mode setting unit, there is an item for setting the picture resolution, the frame rate for display and the speed of consecutive shooting. The item of resolution is selectable from, for example, the resolutions of the VGA (Video Graphics Array) standard and the HDTV (High-Definition TeleVision) standard as a reference. The frame rate for display is an item for selecting either of 30 and 15 (30/15) per second, for example.

The consecutive shooting speed setting unit sets a plural number of the consecutive shooting speeds, i.e. the number of pictures or image frames that may be shot per unit time, to set the speed for consecutive shooting. Preferably, the number of readout outputs is set to three, two or one, depending on the consecutive shooting speed. It is noted that the consecutive shooting speed is an item for setting the consecutive shooting speed for a picture or image composed of a certain number of pixels. If the consecutive shooting speed indicates the number of images of consecutive shooting smaller than a threshold value for consecutive shooting, the readout is set to one-output readout. If the consecutive shooting speed indicates the number of images of consecutive shooting larger than the threshold value for consecutive shooting, and setting is the AE/AF feature, then the readout is set to three-output or two-output readout, and the solid-state image pickup device 40 is operated accordingly.

The shutter release button, now specifically shown, has the function of defining or selecting the operating timing or the operating mode depending on its half-stroke or full-stroke depression. The shutter release button is responsive to the half-stroke depression to bring about the AE or AF operation. These operations allow picture data obtained by moving picture display to be used for founding out optimum values for the diaphragm, the shutter speed and the focal length. A full thrust of the shutter release button causes the recording start/end timing to be transferred to the system controller 30 to define the operating timing consistent with the setting mode of the digital camera 10. The setting mode of the digital camera 10 may include a still image and a moving picture recording mode.

The medium I/F unit 34 has an interface control function of controlling the recording and/or reproduction of image data depending on the recording medium of interest. The medium I/F unit 34 is able to perform write/readout control for image data 168 on or from a PC (Personal Computer) card, in the form of semiconductor recording medium, or to perform the write/readout control under the control of a USB (Universal Serial Bus) controller, now specifically illustrated. The medium 38 is subject to a variety of standards for semiconductor storage cards.

A liquid crystal display monitor may, for example, be used for the display monitor 38. The monitor 38 visualizes and displays image data 154 supplied from the signal processor 22.

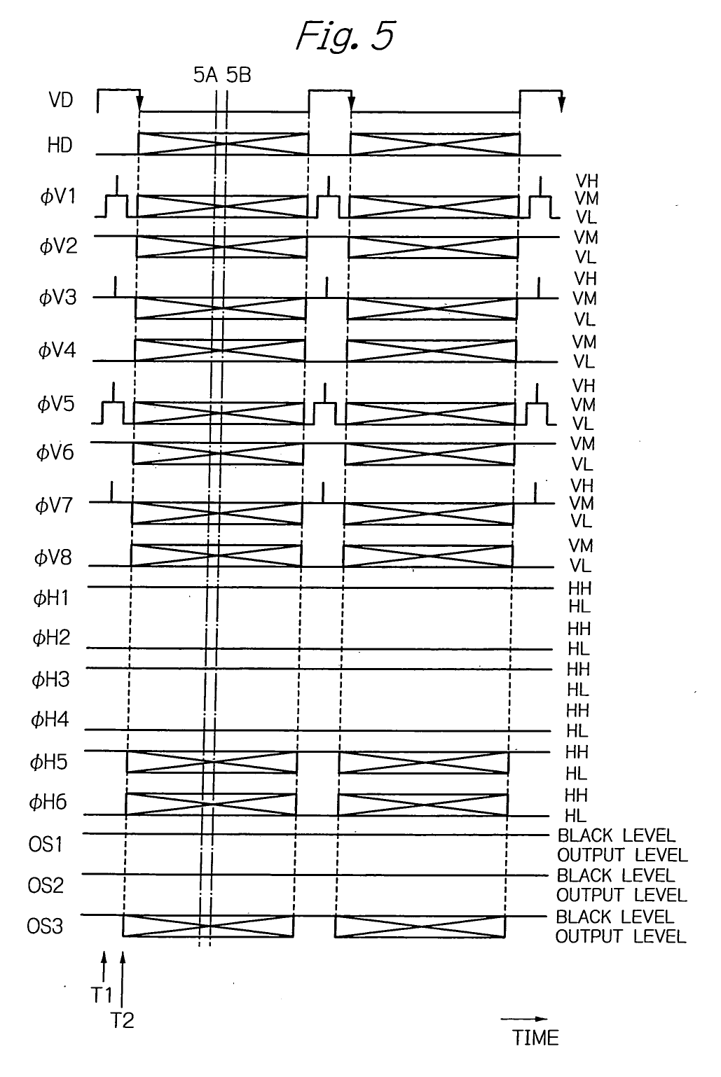

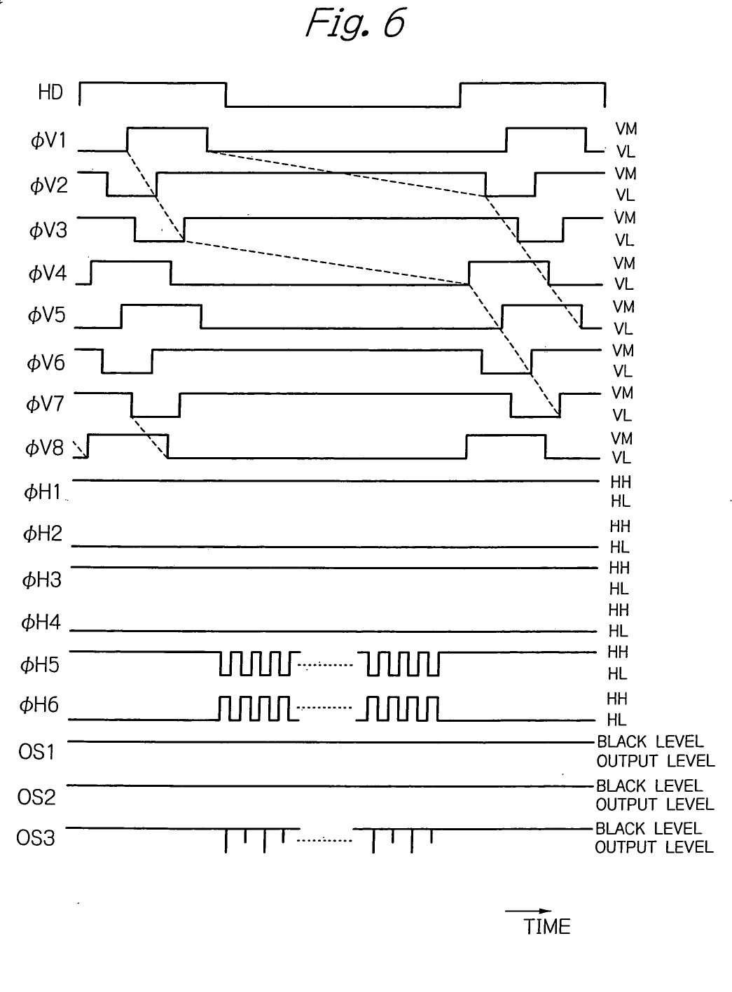

The operation of the image pickup device 40 in the digital camera 10 will now be described. FIG. 5 shows the timings of the vertical and horizontal driving signals and the output signal for one-output readout. The signal charges corresponding to the volume of incident light 13, obtained on light exposure, are stored in the photodiodes 44. The signal charges, thus stored, are read out at time T1 to the vertical transfer path 46. In the image pickup device 40 of the present embodiment, vertical driving signals ΦV1, ΦV3, ΦV5 and ΦV7 are supplied to the field shift gates, so that the signal charges are field-shifted from the photo diodes 44. The image pickup device 40 activates a horizontal synchronous signal HD, in timed with the negative-going edge of the vertical synchronous signal, supplied from the driver 28, to start the transfer of the signal charges as read out at timing T2. The eight-phase driving signals ΦV1 to ΦV8, transmitted from the vertical drivers 88 and 90, FIG. 2, are used for vertical transfer, while the two-phase driving signals ΦH5 and ΦH6, transmitted from the H driver 96, are used for horizontal transfer. The signal charges, supplied by this charge transfer, are output in the form of output signal OS3 from the output amplifier 52. The temporal section defined by two dot-and-dash lines 5A and 5B, FIG. 5, is shown enlarged in FIG. 6, and will be described below in further detail.

As shown in FIG. 6, the vertical driving signals ΦV1 to ΦV8 are sequentially supplied to the electrodes shown in FIG. 2. The signal charges in the potential wells or packets, formed in response to the signal levels VM of the vertical driving signals ΦV1 to ΦV8, are migrated with lapse of time. This migration of the signal charges may be visualized by movements of the packets from below towards above in FIG. 2 when the vertical driving signals ΦV1 to ΦV8 are applied to the electrode structure shown in FIG. 2.

By this packet migration, the signal charges are transferred to the horizontal transfer path 48, FIG. 1. The horizontal driving signals ΦH5 and ΦH6 (106) are applied to the horizontal transfer path 48, with the electrodes 124 and 126 as set. The signal charges in the potential wells or packets, formed by the signal level “HH” of the horizontal driving signals ΦH5 and ΦH6, are migrated with lapse of time. In actuality, the signal charges are migrated towards the output amplifier 52, based on this migration and the electrode structure.

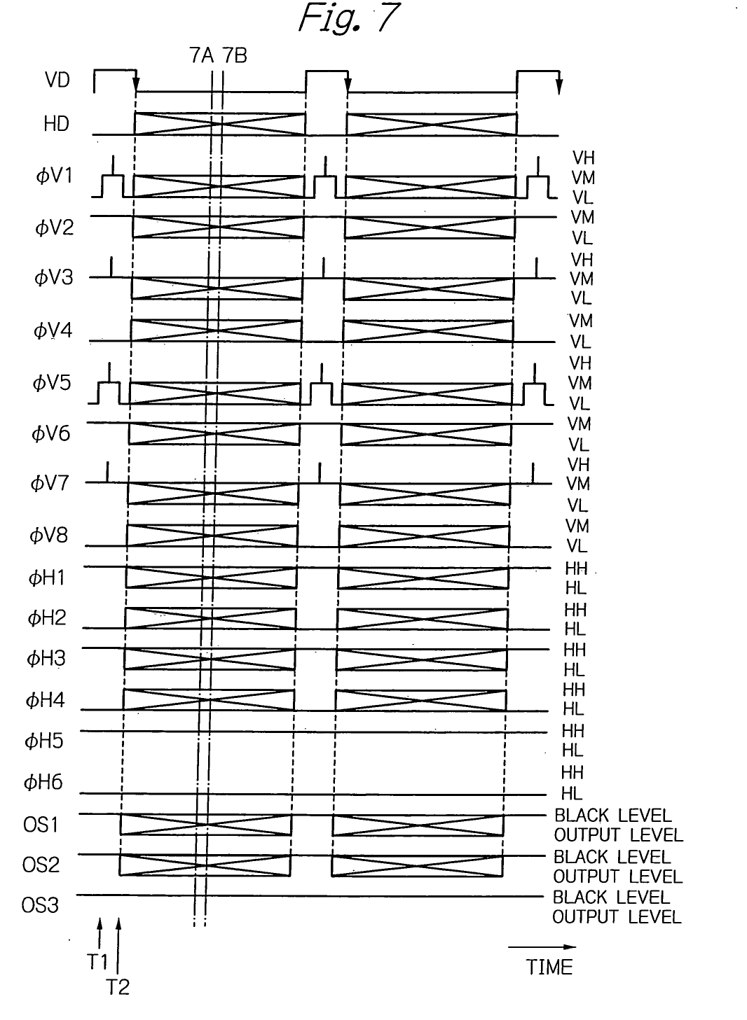

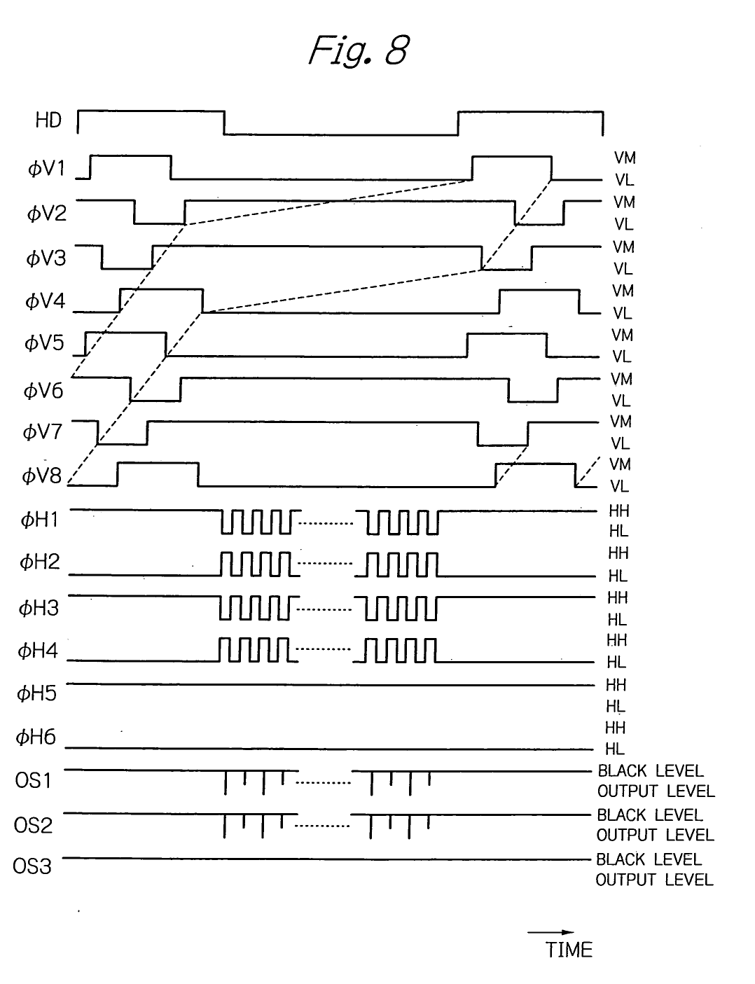

The timings of the vertical driving signals, horizontal driving signals and the output signals for two-output readout are shown in FIG. 7. The signal charges, corresponding to the volume of incident light 13, obtained on light exposure, are stored in the photodiodes 44. The signal charges stored are read out at time t1 to the vertical transfer path 46. In the image pickup device 40 of the instant embodiment, the vertical driving signals ΦV1, ΦV3, ΦV5 and ΦV7 are applied to the field shift gate for field-shifting signal charges from the photodiodes 44. In the image pickup device 40, the horizontal synchronous signal HD is activated in timed with the negative-going edge of the vertical synchronous signal VD, supplied from the vertical drivers 88 and 90, to start the transfer of the read-out signal charges at time T2. For vertical transfer, the vertical driving signals ΦV1 to ΦV8, supplied from the horizontal drivers 92, 94, are used. However, the direction of vertical transfer is reversed from that for one-output readout. For horizontal transfer, the horizontal driving signals ΦH1, ΦH2, ΦH3 and ΦH4, supplied from the horizontal drivers 92, 94, are used. The signal charges, supplied in this manner, are transferred in part towards left in the figure, that is, towards the output amplifier 54, so as to be output as output signal OS1, and in part towards right, that is, towards the output amplifier 56, so as to be output as output signal OS2, with the centerline C as a boundary. The temporal section in FIG. 7, defined by two dot-and-dash lines 7A and 7B, is shown enlarged in FIG. 8, and will be described below in further detail.

The vertical driving signals ΦV8 to ΦV1 are sequentially supplied to the electrodes of FIG. 2, as shown in FIG. 8. The signal charges in the potential wells or packets, formed by the signal levels VM of the vertical driving signals ΦV1 to ΦV8, are migrated with lapse of time. The direction of migration of signal charges is reversed from that of the packets shown in FIG. 6. This migration of the signal charges may be visualized by movements of the packets from above towards below in FIG. 2 when the vertical driving signals ΦV8 to ΦV1 are applied to the electrode structure shown in FIG. 2.

By this packet migration, the signal charges are transferred to the horizontal transfer path 50, FIG. 1. The horizontal driving signals ΦH1 and ΦH2 are supplied to the horizontal transfer path 50 from the horizontal driver 92, while the horizontal driving signals ΦH3 and ΦH4 are supplied to the horizontal transfer path 50 from the horizontal driver 94. On the left side of FIG. 3, the horizontal driving signals ΦH1 and ΦH2 are supplied to the electrodes 124 and 126 as a set. In this case, the signal levels of the horizontal driving signals ΦH2 and ΦH1 become the value “HH” in this order to form potential wells or packets, which are migrated towards left in FIG. 3 with lapse of time, so that signal charges are shifted towards left in FIG. 3. On the other hand, on the right side of FIG. 3, the horizontal driving signals ΦH1, ΦH2, ΦH3 and ΦH4 are independently supplied to the electrodes 124 and 126. In this case, the signal levels of the horizontal driving signals ΦH1, ΦH3, ΦH2 and ΦH4 become the value HH in this order to form potential wells or packets, which are migrated towards right in FIG. 3, in increments of two electrodes, with lapse of time, so that signal charges are shifted towards right in the figure. The horizontal driving signals ΦH1 and ΦH3 are in phase with each other, while the horizontal driving signals ΦH2 and ΦH4 are also in phase with each other. Thus, based on the above migration and electrode structure, the signal charges are transferred in part towards the output amplifier 54 and in part towards the output amplifier 56, with the center line C as a boundary.

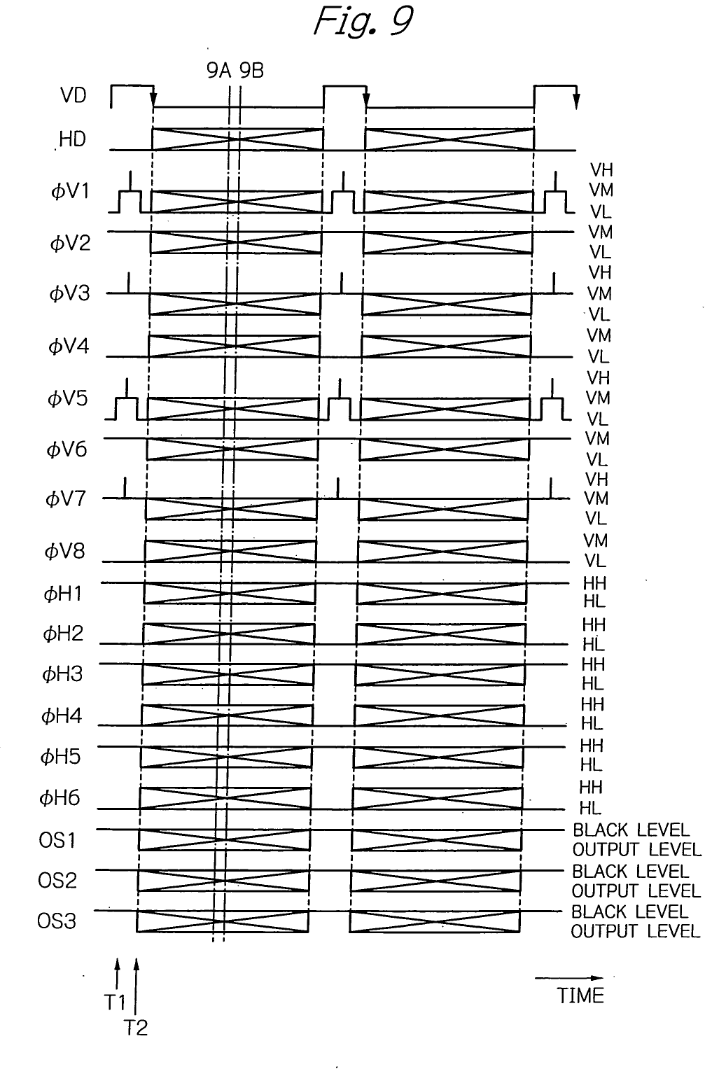

FIG. 9 shows the output timings of the vertical driving signals, horizontal driving signals and the output signals for three-output readout. The signal charges, corresponding to the volume of incident light 13, obtained on light exposure, are stored in the photodiodes 44. The signal charges stored are read out at time T1 to the vertical transfer path 46. In the image pickup device 40 of the instant embodiment, the vertical driving signals ΦV1, ΦV3, ΦV5 and ΦV7 are applied to the field shift gate for field-shifting signal charges from the photodiodes 44. In the image pickup device 40, the horizontal synchronous signal HD is activated in synchronism with the negative-going edge of the vertical synchronous signal VD supplied from the driver 28 to start the transfer of the read-out signal charges at time T2. For vertical transfer, the four-phase driving signals ΦV1 to ΦV4, supplied from the vertical driver 88, and the four-phase driving signals ΦV5 to ΦV8, supplied from the vertical driver 90, are used.

Here, the vertical transfer is in an upward direction as in one-output readout, and in the downward direction, with a boundary 82 for upward vertical transfer and for downward vertical transfer. The two-phase driving signals ΦH1 to ΦH6, supplied from the horizontal drivers 92, 94 and 96, are used for horizontal transfer. The signal charges, supplied in this manner, are transmitted to the output amplifier 52, while being transmitted in part leftwards towards the output amplifier 54 and in part rightwards towards the output amplifier 56, with the centerline C as a boundary. The result is the outputting of the output signals OS1, OS2 and OS3. The temporal section in FIG. 9, defined by two dot-and-dash lines 9A and 9B, is shown enlarged in FIG. 8, and will be described below in further detail.

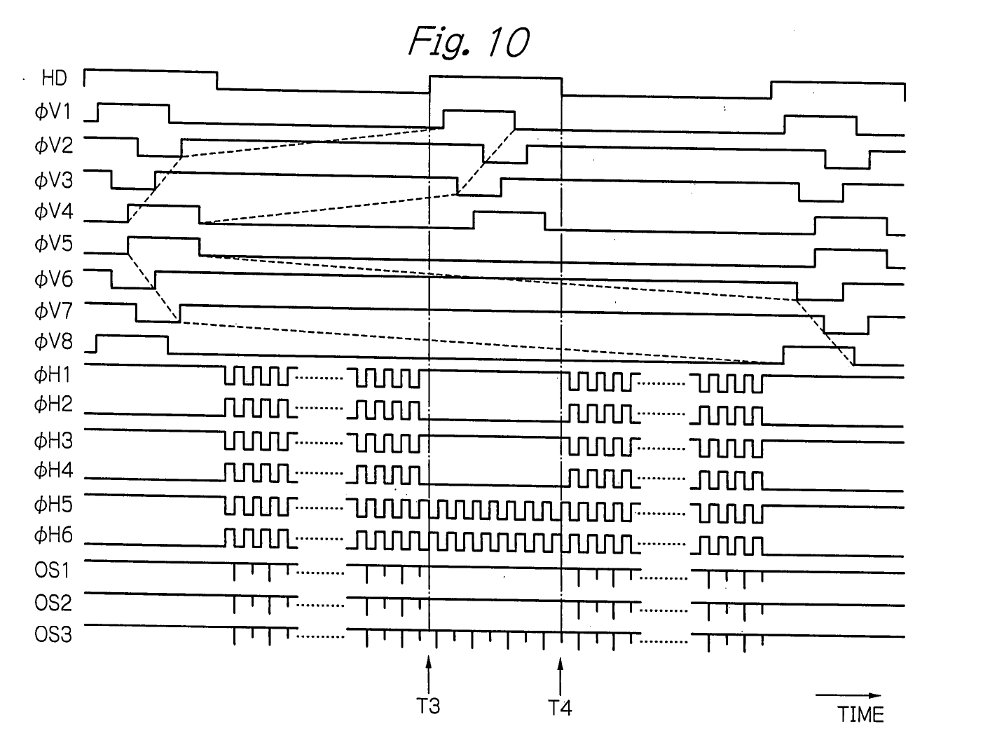

The vertical driving signals ΦV5 to ΦV8 and the vertical driving signals ΦV4 to ΦV1 are sequentially supplied to the electrodes of FIG. 2, as shown in FIG. 10. The signal charges in the potential wells or packets, formed by the signal levels VM of the vertical driving signals ΦV1 to ΦV8, are migrated with lapse of time. When the four-phase vertical driving signals ΦV5 to ΦV8 are applied, the packets are migrated towards the horizontal transfer path 48. When the four-phase vertical driving signals ΦV4 to ΦV1 are applied, the packets are migrated in the opposite direction, that is, towards the horizontal transfer path 50. When the vertical driving signals ΦV8 to ΦV1 are applied, in association with the electrode structure shown in FIG. 2, the packets are migrated from below towards above in the sub-zone 42a of the effective pixel zone 42 as delimited by boundary line 82. In the sub-zones 42b and 42c, the packets are moved from above towards below.

By the above migration, the signal charges, staying in the respective sub-zones, are transferred on the horizontal transfer paths 48 and 50. The horizontal transfer path 50 is supplied with the horizontal driving signals ΦH1 and ΦH2, and with the horizontal driving signals ΦH3 and ΦH4 from the horizontal drivers 92 and 94, respectively. The horizontal driving signals ΦH1 and ΦH2 are applied to the electrodes 124 and 124 as set. In this case, the levels of the signal charges in the potential wells or packets, formed by the horizontal driving signals ΦH2 and ΦH1, take the value HH in this order, so that signal charges are migrated towards left in FIG. 3 with lapse of time. The horizontal driving signals ΦH1 and ΦH2 cease to be supplied during the time interval as from time T3 until time T4, and recommence to be supplied as from time T4.

On the other hand, the horizontal driving signals ΦH1, ΦH2, ΦH3 and ΦH4 are applied to the electrodes 124 and 126 which in this case are independent of each other. In this case, since the “HH” signal level is supplied in the order of the horizontal driving signals ΦH4, ΦH1, ΦH3 and ΦH2, the signal charges in the potential wells or packets, formed in increments of two consecutive electrodes, are migrated with lapse of time towards right in FIG. 3. Those horizontal driving signals ΦH4, ΦH1, ΦH3 and ΦH2 cease to be supplied during the time interval of times T3 and T4. It is noted that the horizontal driving signals ΦH1 and ΦH3 are in phase with each other, while the horizontal driving signals ΦH2 and ΦH4 are in phase with each other. In this case, too, the horizontal driving signals ΦH1, ΦH2, ΦH3 and ΦH4 recommence to be supplied as from time T4.

Even when the horizontal driving signals ΦH1, ΦH2, ΦH3 and ΦH4 cease to be supplied, the horizontal driving signals ΦH5 and ΦH6 continue to be supplied from the horizontal driver 96 to the horizontal transfer path 48. On the other hand, the vertical driving signals ΦV5 to ΦV8 cease to be supplied during the horizontal transfer time. Thus, the output signal OS3 is supplied during two HD periods. The reason is that the number of stages of the horizontal transfer path 48, transferring the signal charges of the output signal OS3, is twice as many as each of the horizontal transfer path sections 50a and 50b, and that the number of stages of the vertical transfer paths in the sub-zone 42a is one-half that in the sub-zone 42b or 42c. Hence, the horizontal transfer period of the output signal OS3 is protracted. Specifically, it may be an occurrence that the output signal OS3 cannot afford to transfer signal charges. This inconvenience may be avoided by adjusting, or halting, the output signals OS1 and OS2 and by transmitting the output signal OS3 during the two HD periods as described above.

By adjusting the transfer time for the signal charges in this manner, it becomes possible to adjust the output timing and period of the output signals OS1 to OS3 so that the output timing and period of the three output signals may be equal to one another.

In the present embodiment, the output timing and period of the output signals OS1 and OS2 are adjusted by halting the transfer of the output signals OS1 and OS2. This is merely illustrative and, for example, the driving frequency for transfer of the output signal OS3 may be set to approximately twice as high as the driving frequency of the output signals OS1 and OS2.

The present invention is not limited to application to a digital camera but may, of course, be applied to a mobile phone, for example, including component parts of the digital camera 10.

The entire disclosure of Japanese patent application No. 2005-312174 filed on Oct. 27, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What I claim is:

1. A solid-state image pickup system comprising a solid-state image pickup device including:
a two-dimensional array of photosensitive cells formed as pixels for photoelectrically transducing incident light into a signal charge;
a vertical transfer path for receiving the signal charge stored in said photosensitive cells for transferring the signal charge in a vertical direction;
a horizontal transfer circuit for receiving the signal charge transferred from said vertical transfer path of transferring the signal charge in a horizontal direction; and
output circuitry arranged in an ultimate stage of said horizontal transfer path for receiving the signal charge from said horizontal transfer path to output an analog signal;
said horizontal transfer circuit comprising a first horizontal transfer path for transferring the signal charge in one direction, and a second horizontal transfer path for transferring the signal charge in part towards left and in part towards right with respect to a boundary position;
said output circuitry comprising a first output circuit for converting the signal charge transferred from said first horizontal transfer path to an analog signal, a second output circuit for converting the signal charge transferred from said second horizontal transfer path towards left to an analog signal, and a third output circuit for converting the signal charge transferred from said second horizontal transfer path towards right to an analog signal;
said system further comprising:
a controller responsive to an operating signal providing at least one of operating, setting and environmental conditions for generating a control signal for exercising control;
a timing generator for generating a timing signal consistent with the control signal; and
a driving generator responsive to the control signal for controlling a driving of said output circuitry and for generating a driving signal from the timing signal consistent with the control signal.

2. The system in accordance with claim 1, wherein said controller generates a control signal for transferring the signal charge read out to said vertical transfer path towards said first horizontal transfer path or towards said second horizontal transfer path.

3. The system in accordance with claim 1, wherein said controller provides a first generation generating a control signal driving said first horizontal transfer path and said first output circuit and halting, in association with the driving, the driving of said second horizontal transfer path and the driving of said second and third output circuits; and
a second generation generating a control signal driving said second horizontal transfer path and said second and third output circuits and halting, in association with the driving, the driving of said first horizontal transfer path and the driving of said first output circuit.

4. The system in accordance with claim 1, wherein said controller generates a control signal by said first generation depending on a setting condition for a mode for shooting at a sensitivity higher than a normal sensitivity for shooting.

5. The system in accordance with claim 1, further comprising a sensor provided in a vicinity of said output circuitry for sensing temperature;
said controller generating a control signal by said first generation responsive to the temperature from said sensor being higher than a first threshold value.

6. The system in accordance with claim 1, further comprising a sensor provided in a vicinity of said output circuitry for sensing temperature;
said controller generating a control signal by said first generation responsive to the temperature from said sensor being lower than a second threshold value.

7. The system in accordance with claim 1, further comprising a sensor provided in a vicinity of said output circuitry for sensing temperature;
said controller generating a control signal by said first generation responsive to a variation in the temperature from said sensor with respect to a predetermined threshold value.

8. The system in accordance with claim 1, wherein said controller generates the control signal by said first generation responsive to the operating signal representing of either of the setting conditions for setting a resolution of moving pictures lower than a standard resolution and for setting a frame rate of moving pictures lower than a standard frame rate.

9. The system in accordance with claim 1, wherein said controller is responsive to the operating signal supplied for instructing at least photometry and focus-ranging to set a predetermined detection area near a center of an image pickup zone;
said controller generating a control signal for sweeping out all signal charges read out from a zone of the image pickup zone excluding the detection area and lying towards said first horizontal transfer path, transferring the signal charge read out from an area of the image pickup zone including the detection area towards said second horizontal transfer path, and reading out the signal charge thus transferred from at least one of said second and third output circuits.

10. The system in accordance with claim 1, wherein said system is a digital camera comprising said solid-state image pickup device.

11. The system in accordance with claim 1, wherein said system is a mobile phone comprising said solid-state image pickup device.

12. A method for driving a solid-state image pickup device, in which photosensitive cells used as pixels for photoelectrically transducing incident light into signal charge are arranged in a two-dimensional array, the signal charge stored in the photosensitive cells is read out and transferred in a vertical direction, and the signal charge transferred in the vertical direction is transferred to an output side so as to be output by a plurality of output circuits configured for converting the signal charge into an analog signal, said method comprising:
a first step of generating a control signal responsive to an operating signal providing at least one of operating, setting and environmental conditions;
a second step of generating vertical and horizontal timing signals consistent with the control signal; and
a third step of controlling the output circuit to single drive or to multiple drive responsive to the control signal supplied, and generating vertical and horizontal driving signals from the vertical and horizontal driving signals consistent with the control signal;
said second step generating the vertical timing signal for providing for vertical transfer directions opposite to each other between a first case of controlling the output circuit to one-output driving and a second case of controlling the output circuit to a multiple-output driving;
said second step generating the horizontal timing signal for said second case for transferring a packet transporting the signal charge in the horizontal transfer towards the output circuit for the multiple-output driving with respect to a predetermined boundary;
the horizontal transfer path being provided with a plurality of output circuits, and having separate interconnections for conveying the horizontal driving signal different on both sides with respect to the predetermined boundary, so that the horizontal driving signal supplied causes the packets transporting the signal charge to be formed in order in the directions towards the output circuits.

13. The method in accordance with claim 12, wherein said first step is responsive to the operating signal to generate a control signal for one-output, two-outputs or three-output driving;
said second step generating the vertical timing signal for providing for one vertical transfer direction for the one-output driving and generating the vertical timing signal for providing for the one vertical transfer direction and for an opposite vertical transfer direction for the two-output driving;
the three-output driving generating the vertical timing signal for providing for the one-output driving and for the two-output driving.

14. The method in accordance with claim 12, wherein said first step is responsive to the operating signal to generate a control signal for one-output driving, two-output driving or three-output driving;
the control signal for the one-output driving being for said first generation and halting the horizontal transfer and outputting other than the horizontal transfer and outputting for the one-output driving;
the control signal for the two-output driving being for said second generation and halting the horizontal transfer and outputting for the one-output driving;
the control signal for the three-output driving driving entirety of the horizontal transfer and the outputting.

15. The method in accordance with claim 12, wherein a control signal by said first generation is generated depending on a setting condition for a mode for shooting at a sensitivity higher than a normal sensitivity for shooting.

16. The method in accordance with claim 12, wherein said first step generates the control signal by said first generation responsive to a temperature obtained being higher than a first threshold value.

17. The method in accordance with claim 12, wherein said first step generates the control signal for said first generation responsive to a temperature obtained being lower than a second threshold value.

18. The method in accordance with claim 12, wherein said first step generates the control signal for said first generation responsive to variation in temperature with respect to a predetermined threshold value.

19. The method in accordance with claim 12, wherein said first step generates the control signal by said first generation at least responsive to the operating signal representing the setting conditions for setting a resolution of moving pictures lower than a standard resolution and for setting a the frame rate of moving pictures lower than a standard frame rate.

20. The method in accordance with claim 12, wherein said first step sets a predetermined area near a center of an image pickup zone, responsive to an operating signal supplied for instructing at least photometry and focus-ranging;
said first step generating a control signal for sweeping out all signal charges read out from a zone of the image pickup zone excluding the detection area and lying towards the one-output driving side, transferring the signal charge read out from an area of the image pickup zone including the detection area towards the second horizontal transfer path, and reading out the signal charge thus transferred from at least one of output sides of the two-output driving.
